(19) United States
(12) Patent Application Publication
(10) Pub. No.: US 2012/0131209 A1
(43) Pub. Date: May 24, 2012

(54) NEARBY ADDRESS NETWORK SERVICE INFORMATION PROVISIONING FOR MARKETING REPRESENTATIVES

(75) Inventors: Sutap Chatterjee, Tampa, FL (US); Premanand Sivakkolundhu, Tampa, FL (US); Nityanand Sharma, Tampa, FL (US)

(73) Assignee: VERIZON PATENT AND LICENSING INC., Basking Ridge, NJ (US)

(21) Appl. No.: 12/950,108

(22) Filed: Nov. 19, 2010

(51) Int. Cl. G06F 15/16

(52) U.S. Cl. 709/228

(57) ABSTRACT

A network device receives a geographic location of a mobile device. The network device accesses a database to identify addresses within a distance parameter of the received geographic location, and retrieves attributes associated with the identified addresses from the database, wherein the attributes comprise attributes associated with one or more network services provided to customers from a network service provider. The network device sends the identified customer addresses and the retrieved network service attributes to the mobile device.

### BACKGROUND

Marketing representatives for companies supplying network services in a geographic area may go door-to-door to attempt to market various network services, such as, for example, phone services or cable network services, to potential or existing customers. In the process of performing door-to-door marketing, the marketing representatives typically manually call nearby customer care centers to obtain information related to specific potential or existing customers, including, for example, customer addresses, network usage information, network capability information for the customer's area, etc.

### BRIEF DESCRIPTION OF THE DRAWINGS

FIG. 1 is a diagram that depicts an overview of the automated provisioning of customer inquiry information via a mobile device according to exemplary embodiments described herein;

FIG. 2 is a diagram that depicts an exemplary environment in which the automated provisioning of customer inquiry information, as described herein, may be implemented;

FIG. 3 is a diagram that depicts exemplary components of the mobile device of FIG. 2;

FIG. 4 is a diagram that depicts exemplary external components of a mobile device of FIG. 2;

FIG. 5 is a diagram that illustrates an exemplary functional diagram of the customer profile application of FIG. 2;

FIG. 6 is a diagram that illustrates an exemplary data table that may be stored in the customer profile database of FIG. 2;

FIGS. 7A and 7B are flow diagrams that illustrate an exemplary process for receiving and displaying nearby customer addresses, attributes of the nearby customer addresses, and marketing offers for the nearby customer addresses at a mobile device;

FIG. 8 is an exemplary messaging diagram associated with the exemplary process of FIGS. 7A and 7B;

FIG. 9 is a diagram that depicts an exemplary interface for displaying nearby customer addresses, attributes associated with the nearby customer addresses, and marketing offers for the nearby customer addresses; and

FIGS. 10A and 10B are flow diagrams that illustrate an exemplary process, implemented at a server, for obtaining and sending customer addresses that are nearby a geographic location, obtaining and sending attributes of the nearby customer addresses, and obtaining and sending marketing offers for the nearby customer addresses to the mobile device of FIG. 2.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

In embodiments described herein, marketing representatives, while performing door-to-door marketing to market network services, may use customer information provided in an automated fashion via an application installed on their mobile devices. The marketing representatives, using embodiments described herein, may obtain information related to specific potential or existing customers, including, for example, customer addresses, network usage information, network capability information for the customer's area, etc., via their mobile devices without having to manually call nearby customer care centers. They may also obtain specific marketing offers, generated based on details of a given customer's network service usage, or based on other customer information, via the application installed on their mobile devices in an automated fashion. Exemplary embodiments described herein, therefore, permit a more time and cost efficient marketing of network services (e.g., upgrades and/or new services) to potential or existing network service customers.

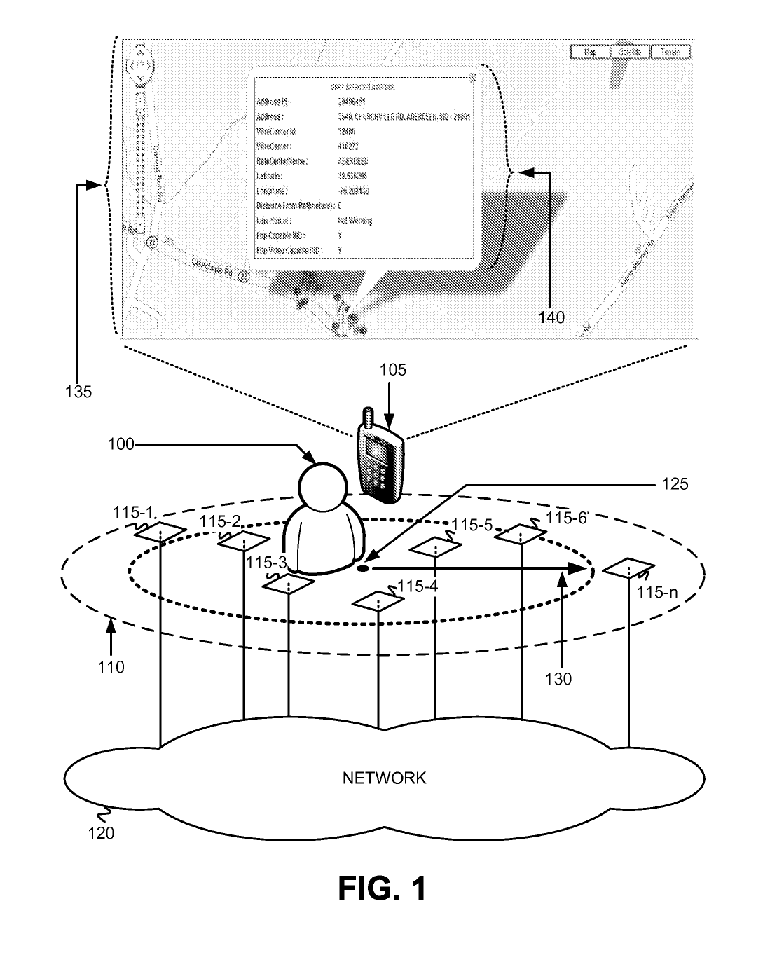

FIG. 1 is a diagram that depicts an overview of the automated provisioning of customer information via a mobile device according to exemplary embodiments described herein. As shown in FIG. 1, a marketing representative 100 (or other individual), associated with a network service provider and carrying a mobile device 105, may roam to a specific geographic area 110. Multiple existing customer addresses 115-1 through 115-n may reside within geographic area 110. As shown in FIG. 1, a network 120, operated by the network service provider, may provide one or more network services to each of the customer addresses 115-1 through 115-n.

As marketing representative 100 roams through geographic area 110, mobile device 105 may obtain a geographic position 125 of mobile device 105 (e.g., using Global Positioning System (GPS) functionality incorporated into mobile device 105). Mobile device 105 may send the obtained geographic position 125 to a server device (not shown), which may access a customer profile database (not shown) to obtain address information associated with the customer addresses located within a configurable distance parameter 130. The server device may additionally access the customer profile database to obtain attributes of the customer addresses located within the configurable distance parameter. The attribute may include mailing address information, a customer address unique identifier, geographic location information (e.g., latitude & longitude) and various types of network service information associated with the network service(s) provided to the customer addresses via network 120. The network service information may include any type of information associated with any network service(s) that is provided to the customer address, such as, for example, Fiber-to-the-Premises (FTTP) capability (including video capability), Optical Network Terminal (ONT) information (e.g., whether it is installed, Session Initiation Protocol (SIP) enabled, digital voice capability, etc.), wire center and rate center information (e.g., wire center identifier, rate center name), and/or line status information. The server device may send the address information and the attributes to mobile device 105 for display via a user interface 135 that maps the customer addresses, and which may selectively provide the attribute information via, for example, an attribute window 140 in user interface 135.

The server device may also, based on the geographic location and the customer address information and attribute information previously retrieved, generate marketing offers for selected customer addresses and may send those marketing offers to mobile device 105. The marketing offers may include service discounts for upgrading existing network services, for adding to existing network services, etc. The marketing offers, including the specific details of the marketing offers, may be selectively displayed via user interface 135 to marketing representative 100 for assistance in providing service offers (e.g., service upgrades, etc.) to customers residing at the customer addresses.

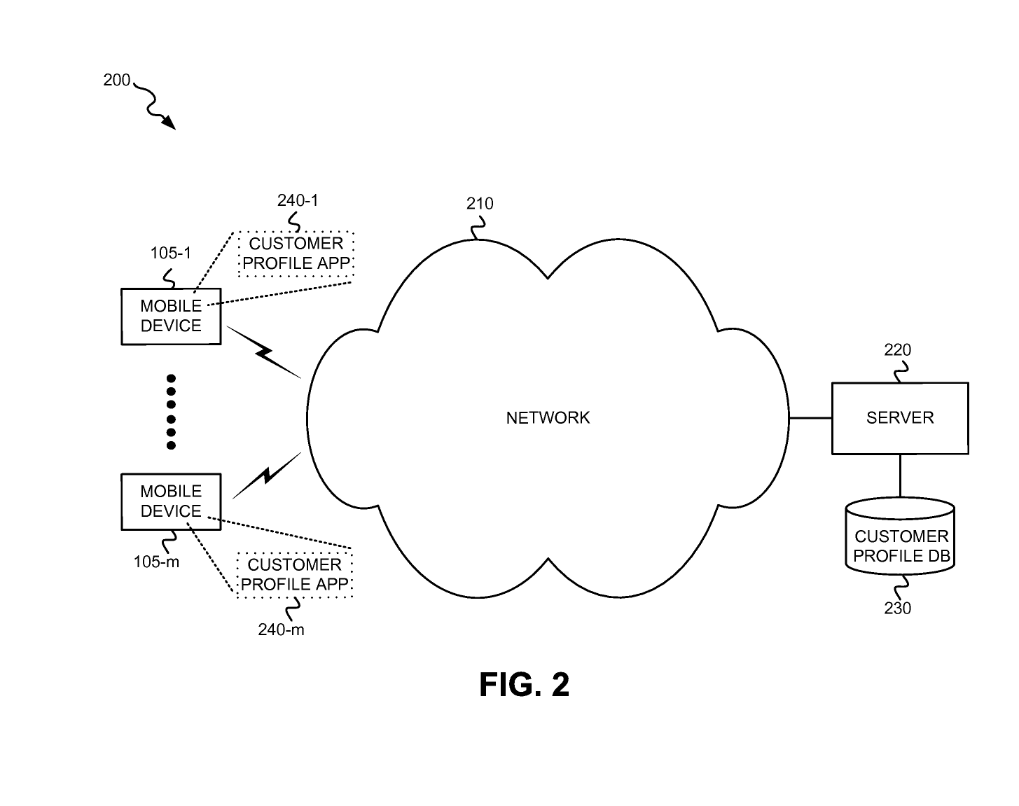

FIG. 2 is a diagram that depicts an exemplary environment 200 in which the automated provisioning of customer information may be implemented. Environment 200 may include multiple mobile devices 105-1 through 105-m (generically and individually referred to herein as “mobile device 105”), a network 210, a server 220, and a customer profile database (DB) 230.

Mobile devices 105-1 through 105-m may each include a mobile computational device that includes wireless communication capabilities. Mobile devices 105-1 through 105-m may, for example, each include a laptop, palmtop or tablet computer, a cellular telephone (e.g., smart phone), or a personal digital assistant (PDA). Mobile devices 105-1 through 105-m may each include wireless transceivers for communicating via network 210. Each one of mobile devices 105-1 through 105-m may include a respective customer profile application (App) 240-1 through 240-m (generically and individually referred to herein as “customer profile app 240”). Customer profile app 240 may include functionality for displaying a user interface that can display geographic maps associated with customer address information, and attributes associated with customer addresses. The attributes may include information associated with the customer address, including network service information.

Network 210 may include one or more wireless networks in addition to one or more other types of networks. The wireless networks may include wireless satellite networks and/or wireless public land mobile networks (PLMNs). The PLMN(s) may include a Code Division Multiple Access (CDMA) 2000 PLMN, a Global System for Mobile Communications (GSM) PLMN, a Long Term Evolution (LTE) PLMN and/or other types of PLMNs. The one or more other types of networks may connect to the one or more wireless networks and may include any type of network, such as, for example, a telecommunications network (e.g., a Public Switched Telephone Network (PSTN)), a local area network (LAN), a wide area network (WAN), a metropolitan area network (MAN), an intranet, the Internet, or a cable network (e.g., an optical cable network).

Server 220 may include a network device that may provide customer address information and attributes associated with customer addresses based on geographic location information received from mobile devices 105-1 through 105-m. Server 220 may access customer profile DB 230 to identify customer addresses within a configurable distance parameter of a geographic location received from mobile device 105. Server 220 may further access customer profile DB 230 to retrieve attributes associated with each identified customer address within the configurable distance parameter. Server 220 may send the identified customer addresses, and the corresponding attributes, to mobile device 105.

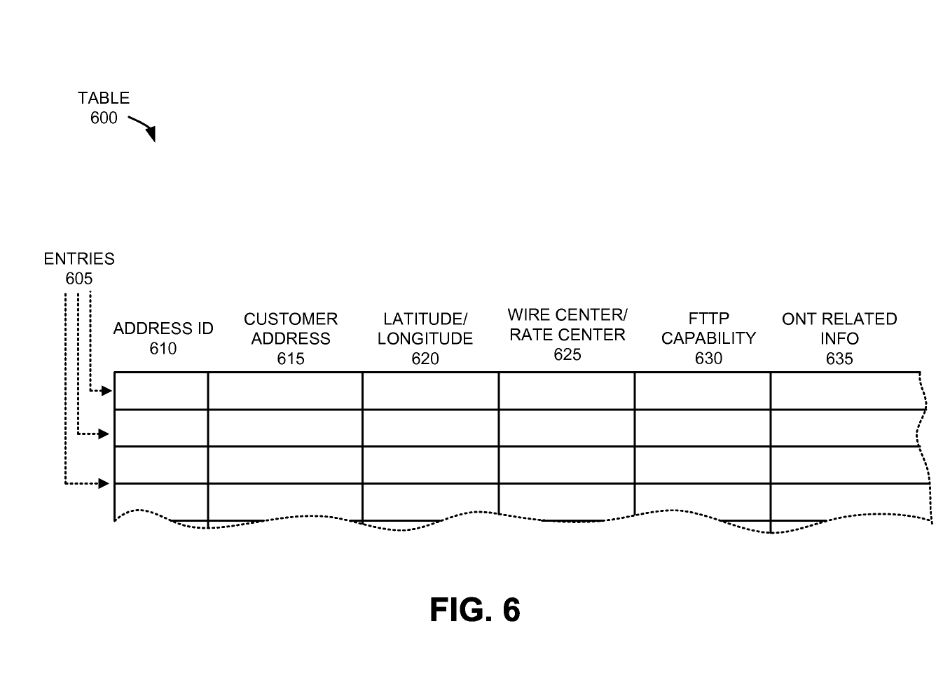

Customer profile DB 230 may store a data table, described below with respect to FIG. 6, which may store various data associated with each customer address. The various data may include latitude and longitude information associated with each customer address, and different types of network service attributes associated with each customer address (e.g., FTTP capability (including video capability), ONT information (e.g., whether it is installed, SIP enabled, digital voice capability, etc.), wire center and rate center information (e.g., wire center identifier, rate center name), and/or line status information).

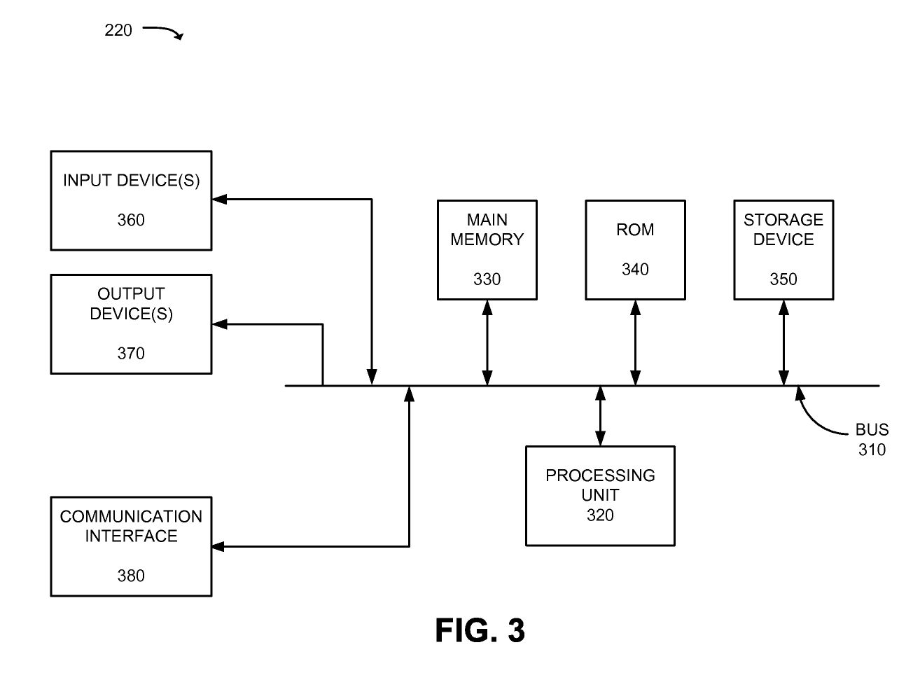

FIG. 3 is a diagram that depicts exemplary components of server 220. Server 220 may include a bus 310, a processing unit 320, a main memory 330, a read only memory (ROM) 340, a storage device 350, an input device(s) 360, an output device(s) 370, and a communication interface 380. Bus 310 may include a path that permits communication among the elements of server 220.

Processing unit 320 may include a processor, microprocessor, or processing logic that may interpret and execute instructions. Main memory 330 may include a random access memory (RAM) or another type of dynamic storage device that may store information and instructions for execution by processing unit 320. ROM 340 may include a ROM device or another type of static storage device that may store static information and instructions for use by processing unit 320. Storage device 350 may include a magnetic and/or optical recording medium.

Input device 360 may include one or more mechanisms that permit an operator to input information to server 220, such as, for example, a keypad or a keyboard, voice recognition and/or biometric mechanisms, etc. Output device 370 may include one or more mechanisms that output information to the operator, including a display, a speaker, etc. Communication interface 380 may include any transceiver mechanism that enables server 220 to communicate with other devices and/or systems. For example, communication interface 380 may include mechanisms for communicating with another device or system via a network, such as network 210.

Server 220 may perform certain operations or processes, as described herein. Server 220 may perform these operations in response to processing unit 320 executing software instructions contained in a computer-readable medium, such as memory 330. A computer-readable medium may include a physical or logical memory device. A logical memory device may include memory space within a single physical memory device or spread across multiple physical memory devices.

The software instructions may be read into main memory 330 from another computer-readable medium, such as storage device 350, or from another device via communication interface 380. The software instructions contained in main memory 330 may cause processing unit 320 to perform operations or processes that are described below. Alternatively, hardwired circuitry may be used in place of or in combination with software instructions to implement processes described herein. Thus, exemplary implementations are not limited to any specific combination of hardware circuitry and software.

The configuration of components of server 220 illustrated in FIG. 3 is for illustrative purposes only. Other configurations may be implemented. Therefore, server 220 may include additional, fewer and/or different components than those depicted in FIG. 3. Mobile device 105 may be configured similarly to server 220, as depicted in FIG. 3, with communication interface 380 including a wireless transceiver for communicating with a wireless satellite network or wireless PLMN via a wireless connection. Mobile device 105 may additionally include a Global Positioning System (GPS) unit (not shown in FIG. 3) that permits mobile device 105 to identify a current location of mobile device 105 using signals received from a GPS satellite system.

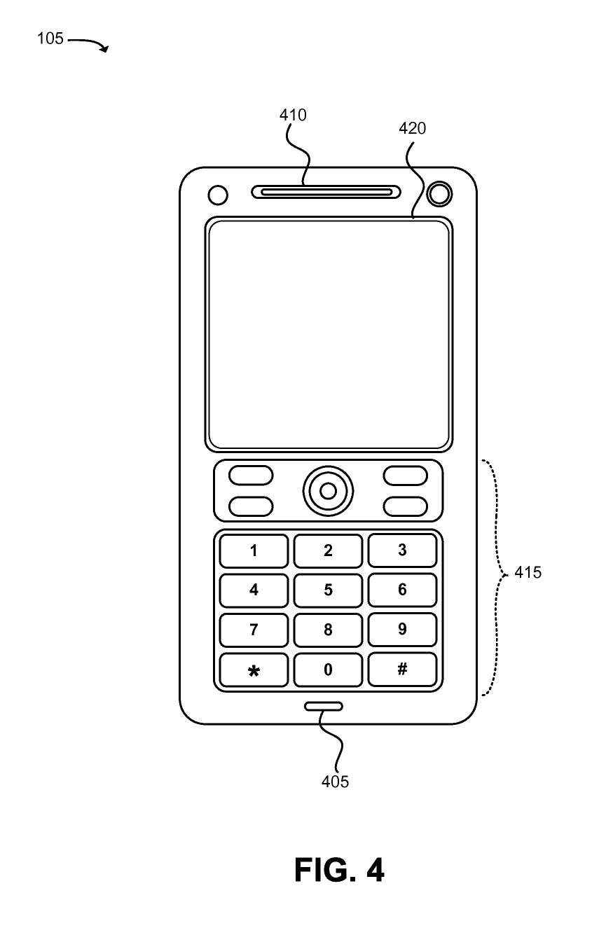

FIG. 4 is a diagram that depicts exemplary external components of mobile device 105 of FIG. 2, in an exemplary implementation in which mobile device 105 includes a mobile telephone. As shown in FIG. 4, mobile device 105 may include a microphone 405 (e.g., of input devices 360), a speaker 410 (e.g., of output devices 370), a keypad 415 (e.g., of input devices 360), and a display 420 (e.g., of output devices 370 and possibly input devices 360). Microphone 405 may convert audio input into electrical signals that can be processed by mobile device 105. Speaker 410 may convert electrical signals into audio output that can be heard by a user of mobile device 105. Keypad 415 may enable the user to “key” in control inputs to mobile device 105. Display 420 may enable the display of various menus and/or information associated with the operation of mobile device 105. In some implementations, display 420 may include a touch panel that permits the user to enter control inputs via application of “touches” to appropriate locations on display 420. In additional implementations, mobile device 105 may have keypad 415 eliminated in its entirety, with all control inputs being applied via the touch panel of display 420. As described further herein, display 420 may display a user interface that presents a geographic map, customer address information, and attribute information associated with each customer address, based on a determined geographic location of mobile device 105.

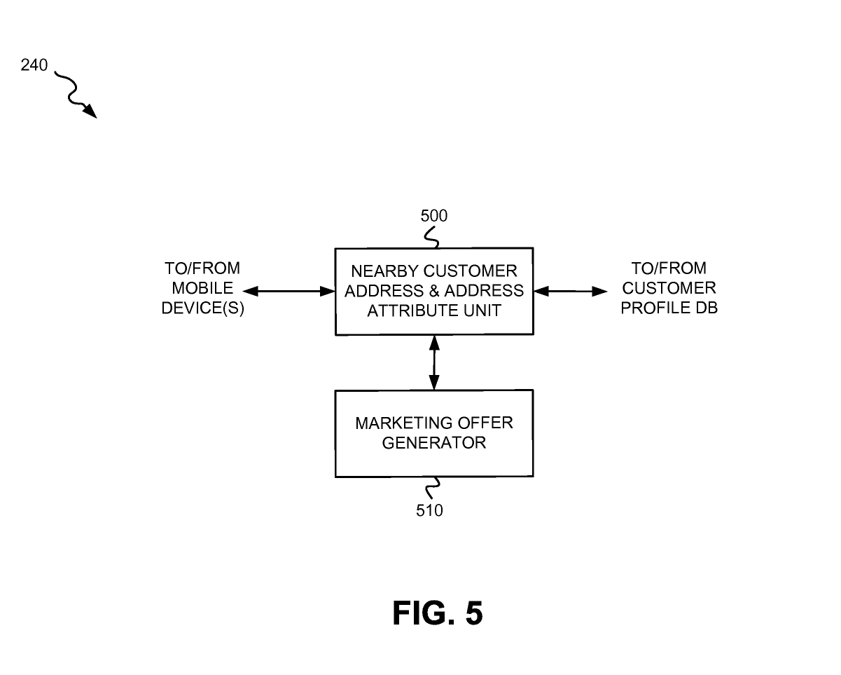

FIG. 5 is a diagram that illustrates an exemplary functional diagram of a customer profile app 240 installed at server 220 of FIG. 2. Customer profile app 240 may include a nearby customer address and address attribute unit 500, and a marketing offer generator 520. The functional components of customer profile app 240 may be implemented by processing unit 320, possibly in conjunction with memory 330, ROM 340, and/or storage device 350.

Nearby customer address and address attribute unit 500 may receive geographic location information from mobile device 105 and may access customer profile DB 230 to obtain nearby customer addresses within a configurable distance parameter of the received geographic location information. Unit 500 may additionally access customer profile DB 230 to retrieve attributes of the nearby customer addresses. Unit 500 may send the nearby customer address information and attributes to mobile device 105 via network 210. Unit 500 may additionally provide the customer address information and attributes to marketing offer generator 510. Marketing offer generator 510 may generate details of marketing offers for each customer address received from unit 500 based on the attributes, and other information, received from unit 500. Marketing offer generator 510 may provide the marketing offer details to unit 500 for sending to mobile device 105.

The configuration of functional components of customer profile app 240 illustrated in FIG. 5 is for illustrative purposes only. Other configurations may be implemented. Therefore, customer profile app 240 may include additional, fewer and/or different functional components than those depicted in FIG. 5.

FIG. 6 is a diagram that illustrates an exemplary data table 600 that may be stored in customer profile DB 230 of FIG. 2. Table 600 may include multiple entries 605, each of which may include an address identifier (ID) field 610, a customer address field 615, a latitude/longitude field 620, a wire center/rate center field 625, a FTTP capability field 630, and an ONT related information field 635.

Address ID field 610 may store a unique identifier associated with the customer address stored in customer address field 615. Customer address field 615 may store a mailing address, including a street address, for a specific customer address located at the geographic location specified in latitude/longitude field 620. Latitude/longitude field 620 may store the latitude and longitude of the customer address specified in customer address field 615.

Wire center/rate center field 625 may store a wire center name/ID and/or a rate center name/ID. FTTP capability field 630 may store information that indicates whether a network service provided to the customer address identified in field 615 is FTTP capable.

ONT related information field 635 may store information related to whether ONT is installed at the customer address identified in field 615, whether the ONT is SIP enabled, and whether the ONT is digital voice capable.

The different fields of data table 600 shown in FIG. 6 are shown for illustrative purposes only. Other table configurations may be implemented. Therefore, data table 600 may include additional, fewer and/or different fields than those depicted in FIG. 6.

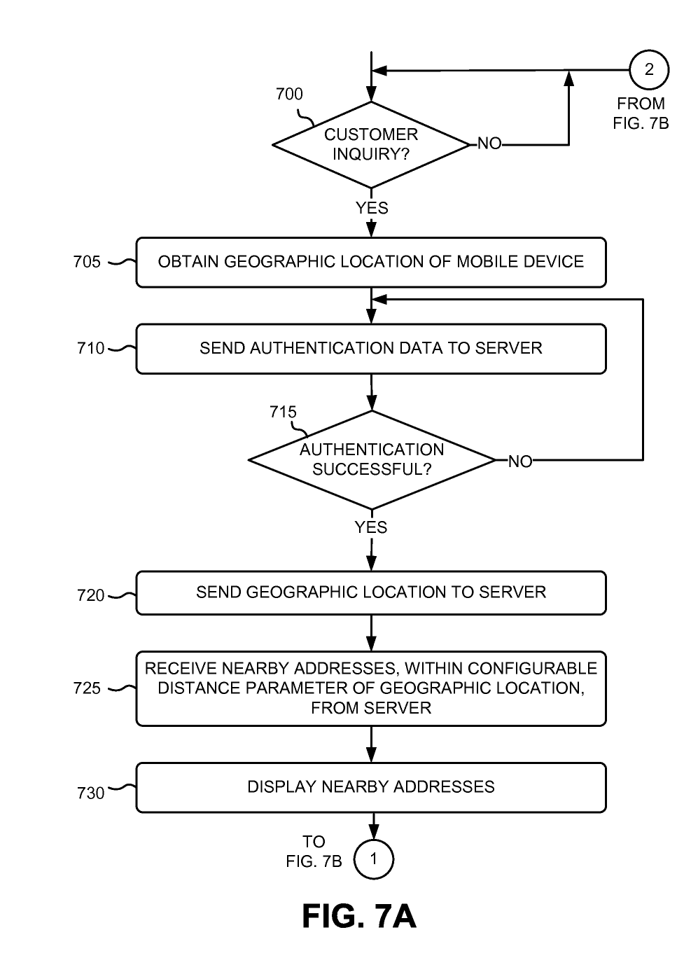

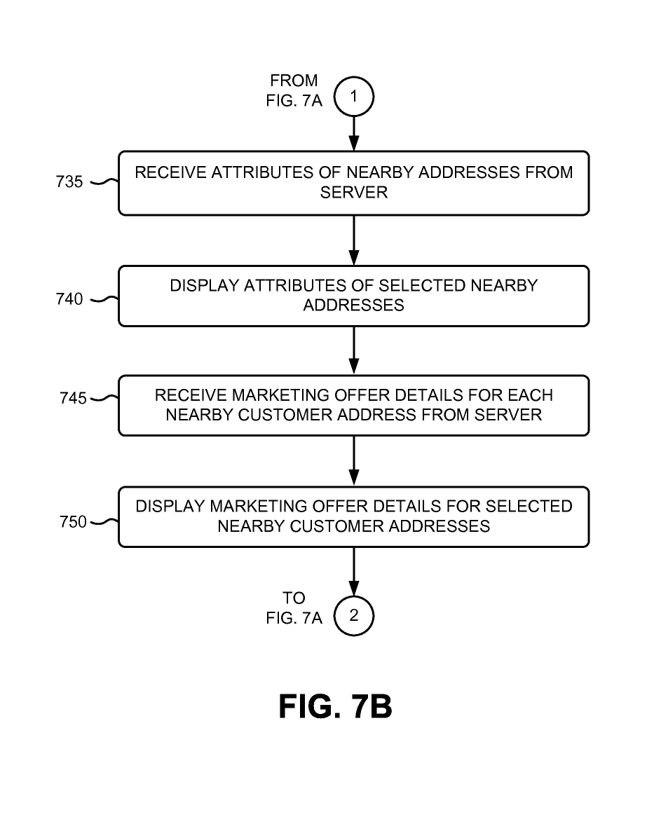

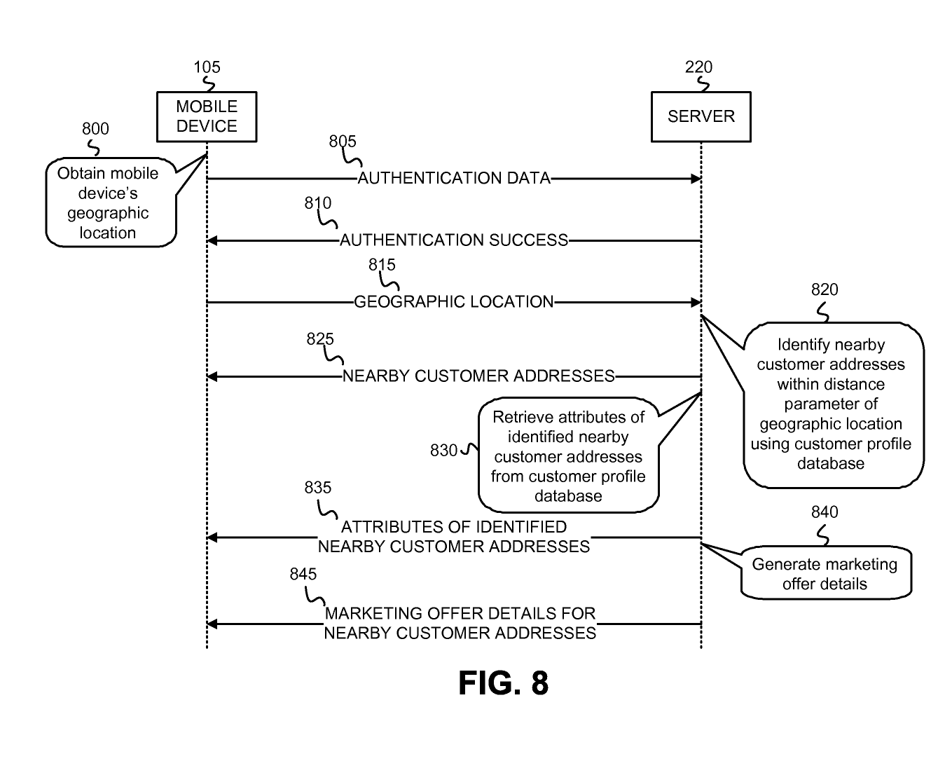

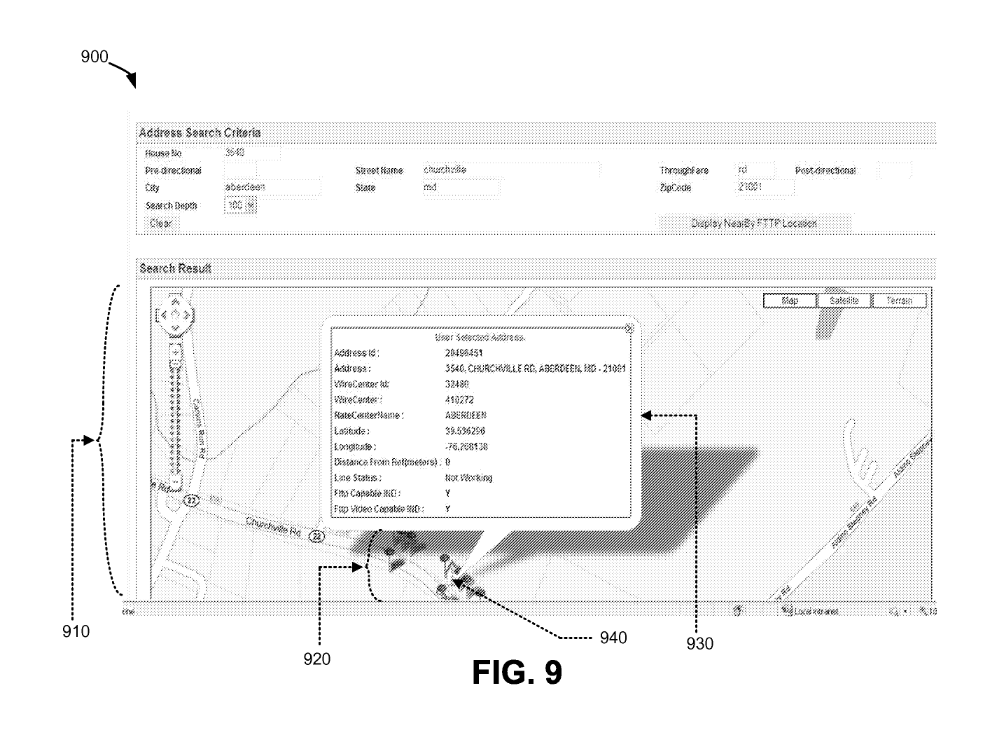

FIGS. 7A and 7B are flow diagrams that illustrate an exemplary process for receiving and displaying nearby customer addresses, attributes of the nearby customer addresses, and marketing offers for the nearby customer addresses at mobile device 105. The exemplary process of FIGS. 7A and 7B may be implemented by mobile device 105. The description of the exemplary process of FIGS. 7A and 7B below may refer to the exemplary messaging diagram of FIG. 8, and the exemplary interface for displaying customer addresses and attributes of FIG. 9.

The exemplary process may include determining if there is a customer inquiry (block 700). The marketing representative using mobile device 105 may enter a customer inquiry via keypad 415 and/or via the touch panel of display 420. The customer inquiry may be initiated, for example, by the marketing representative selecting a “button” on the user interface displayed on display 420. If there is a customer inquiry (YES—block 700), then a geographic location of mobile device 105 may be obtained (block 705). In one exemplary implementation, mobile device 105 may use its GPS unit to obtain a precise geographic location of mobile device 105. In other implementations, different geographic location determining techniques may be used (e.g., triangulation using the wireless PLMN, etc.). The exemplary messaging diagram of FIG. 8 depicts mobile device 105 obtaining 800 its geographic location. If there is no customer inquiry (NO—block 700), the exemplary process may wait, at block 700, until a customer inquiry is received.

Authentication data may be sent to server 220 (block 710). Once a customer inquiry is initiated, and a geographic location of mobile device 105 is obtained, mobile device 105 may send authentication data to server 220 via network 210. The authentication data may include any type of data used in existing authentication techniques. Such authentication data may include, for example, an authentication token that can be authenticated by server 220. FIG. 8 depicts a message 805, including authentication data, being sent from mobile device 105 to server 220. A determination may be made whether the authentication was successful (block 715). Server 220 may, upon receipt of the authentication data from mobile device 105, authenticate the data and may then return an authentication failure or authentication success message to mobile device 105. FIG. 8 depicts server 220 returning an authentication success message 810 to mobile device 105.

If the authentication was not successful (NO—block 715), then the exemplary process may return to block 710 with another attempt by mobile device 105 to send authentication data to server 220. If the authentication was successful (YES—block 715), then the mobile device 105's geographic location may be sent to server 220 (block 720). FIG. 8 shows a current geographic location 815 of mobile device 105 being sent from mobile device 105 to server 220.

Nearby addresses, that are within a configurable distance parameter of the geographic location of mobile device 105, may be received from server 220 (block 725). Server 220 may return data that includes details of nearby customer addresses that within the distance parameter of the geographic location sent from mobile device 105 to server 220. FIG. 8 depicts server 220 identifying 820 nearby customer addresses within the distance parameter of geographic location 815 sent from mobile device 105 to server 220. FIG. 8 further shows server 220 returning the identified nearby customer addresses 825 to mobile device 105.

The received nearby addresses may be displayed (block 730). FIG. 9 depicts an exemplary user interface 900 that may be displayed on display 420 of mobile device 105. User interface 900 may display a geographic map 910 with the nearby addresses being displayed as icons 920 on the map 910.

Attributes of the nearby address may be received from server 220 (block 735). Referring to the messaging diagram of FIG. 8, server 220 is shown as sending a message 835, that includes attributes 835 of nearby customer addresses, to mobile device 105 after having retrieved 830 the attributes from customer profile database 230. Received attributes of selected nearby addresses may be displayed (block 740). FIG. 9 depicts the display of a window 930 that includes customer address attributes of a customer address 940 selected by the marketing representative using mobile device 105. For example, in an implementation in which display 420 of mobile device 105 includes a touch panel, the marketing representative may touch an icon on map 910 that corresponds to the customer address of which the marketing representative desires to obtain the attributes. Upon touching the icon on map 910, window 930 is displayed that presents various customer address attributes, including network service attributes. The attributes displayed in window 930 may include mailing address information, a customer address unique identifier, geographic location information (e.g., latitude & longitude) and various types of network service information associated with the network service(s) provided to the customer addresses. The network service information may include any type of information associated with any network service(s) that is provided to the customer address, such as, for example, FTTP capability (including video capability), ONT information (e.g., whether it is installed, SIP enabled, digital voice capability, etc.), wire center and rate center information (e.g., wire center identifier, rate center name), and/or line status information.

Marketing offer details may be received for each nearby customer address from server 220 (block 745). As shown in FIG. 8, server 220 may generate 840 marketing offer details and may send a message 845 with the marketing offer details for receipt at mobile device 105. The received marketing offer details for selected nearby customer addresses may be displayed (block 750). The marketing offers may include service discounts for upgrading existing network services, for adding to existing network services, etc. The marketing offer details may be displayed, for example, in a separate window (not shown) in user interface 900 at mobile device 105.

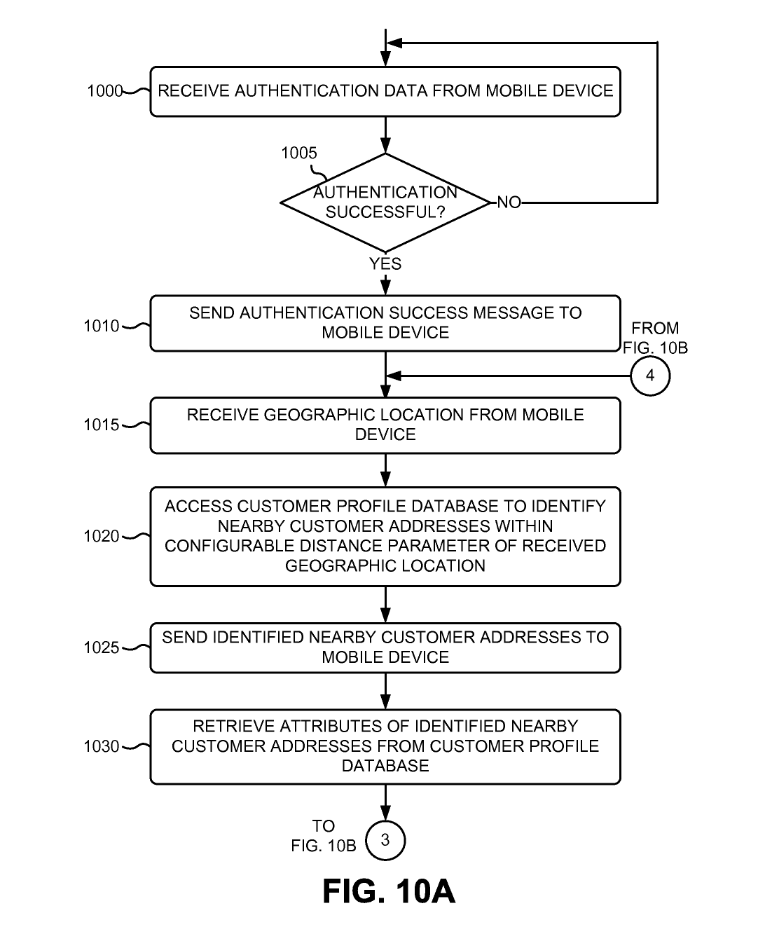

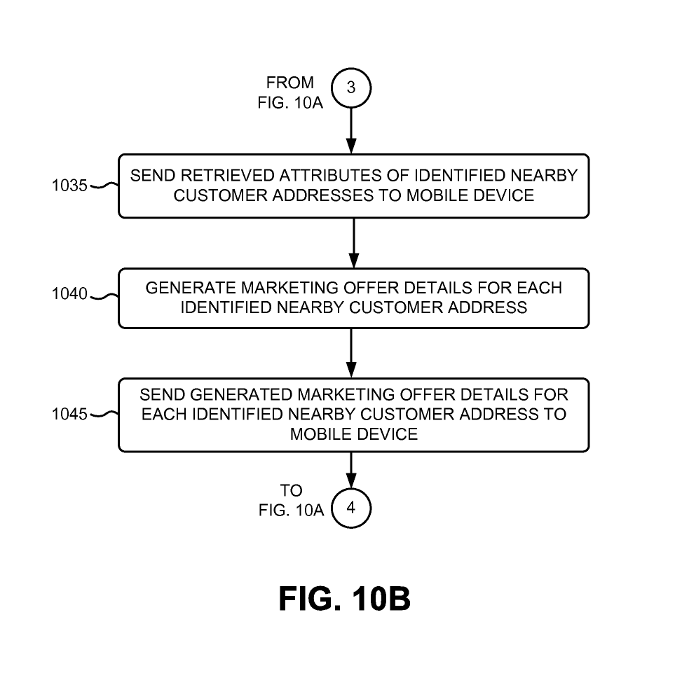

FIGS. 10A and 10B are flow diagrams that illustrate an exemplary process for obtaining and sending customer addresses that are nearby a geographic location, obtaining and sending attributes of the nearby customer addresses, and obtaining and sending marketing offers for the nearby customer addresses to a mobile device 105. The exemplary process of FIGS. 10A and 10B may be implemented by server 220. The description of the exemplary process of FIGS. 10A and 10B below may refer to the exemplary messaging diagram of FIG. 8.

The exemplary process may include receiving authentication data from mobile device 105 (block 1000). As shown in FIG. 8, server 220 may receive a message 805 that includes authentication data from mobile device 105. A determination may be made whether the authentication was successful (block 1005). Server 220 may attempt to authenticate the authentication data from mobile device 105 using existing authentication techniques. If the authentication was not successful (NO—block 1005), then the exemplary process may return to block 1000. If the authentication was successful (YES—block 1010), then an authentication success message may sent to mobile device 105 (block 1010). FIG. 8 depicts server 220 sending an authentication success message 810 to mobile device 105.

A geographic location may be received from mobile device 105 (block 1015). As shown in FIG. 8, server 220 may receive a message 815 from mobile device 105 that includes the geographic location of mobile device 105. Customer profile database 230 may be accessed to identify nearby customer addresses that are within a configurable distance parameter of the geographic location received in block 1015 (block 1020). Unit 500 of server 220 may access table 600 stored in customer profile database 230 to identify nearby customer addresses that are within the configurable distance parameter of the geographic location. Unit 500 may access table 600 to identify all entries 605 that has a value in latitude/longitude field 620 that is within the configurable distance of the geographic location received from mobile device 105.

The identified nearby customer addresses may be sent to mobile device 105 (block 1025). Referring to FIG. 8, server 220 is shown sending a message 825 that includes the identified nearby customer addresses to mobile device 105. Attributes of the identified nearby customer addresses may be retrieved from customer profile database 230 (block 1030). Unit 500 of server may access table 600 to retrieve data stored in fields 625, 630, and 635. FIG. 8 depicts server 220 retrieving 830 attributes of identified nearby customer addresses from customer profile database 230. The retrieved attributes of the identified nearby customer addresses may be sent to mobile device 105 (block 1035). Referring to FIG. 8, server 220 is shown sending a message 835 that includes the retrieved attributes of nearby customer addresses.

Marketing offer details for each of the identified nearby customer addresses may be generated (block 1040). The marketing offer details may be generated based on information obtained by server 220 in blocks 1015, 1020, and/or 1030. The marketing offers may include service discounts for upgrading existing network services, and/or for adding to existing network services. FIG. 8 depicts server 220 generating 840 marketing offer details. The generated marketing offer details for each of the identified nearby customer address may be sent to mobile device 105 (block 1045). FIG. 8 shows server 220 sending a message 845 that includes marketing offer details for nearby customer addresses to mobile device 105.

Exemplary embodiments described herein enable the automated provisioning of information related to specific potential or existing customers of network services via mobile devices, including, for example, customer addresses, network usage information, network capability information for the customer's area, etc. Marketing representatives, while performing door-to-door marketing to market network services, may obtain the customer information via applications installed on their mobile devices, and may also obtain marketing offers that may be presented to the customers.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with regard to FIGS. 7A, 7B, 10A and 10B, the order of the blocks may be modified in other embodiments. Further, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, at a network device, a geographic location of a mobile device;
accessing, at the network device, a database to identify customer addresses within a distance parameter of the received geographic location;
retrieving network service attributes associated with the identified customer addresses from the database; and
sending the identified customer addresses and the retrieved network service attributes to the mobile device for use in network service marketing.

2. The method of claim 1, further comprising:
generating marketing offers associated with one or more network services for one or more of the identified addresses, and
sending the generated marketing offers to the mobile device.

3. The method of claim 2, wherein the marketing offers include discounts for upgrading existing network services or for adding to existing network services.

4. The method of claim 1, wherein the network service attributes include information associated with one or more network services that are provided to the customer addresses.

5. The method of claim 4, wherein the network service attributes include at least one of Fiber-to-the-Premises (FTTP) capability, Optical Network Terminal (ONT) information, wire center and rate center information, or line status information.

6. The method of claim 5, where the ONT information includes at least one of ONT installation information, Session Initiation Protocol (SIP) enablement information, or digital voice capability.

7. The method of claim 5, wherein the wire center and rate center information includes a wire center identifier and a rate center name.

8. The method of claim 1, wherein the geographic location comprises a latitude and longitude.

9. A computer-readable medium containing instructions executable by at least one processor, the computer-readable medium comprising:
one or more instructions for obtaining a geographic location of a mobile device;
one or more instructions for sending a geographic location associated with the mobile device to a remote network device;
one or more instructions for receiving addresses of customers who subscribe to a network service that are within a distance parameter of the geographic location from the remote network device;
one or more instructions for receiving network service attributes associated with the addresses of the customers from the remote network device; and
one or more instructions for displaying the addresses of the customers on a digital map and for displaying the network service attributes for at least one of the addresses in association with the digital map.

10. The computer-readable medium of claim 9, wherein the network service attributes include information associated with one or more network services that are provided to the addresses of the customers.

11. The computer-readable medium of claim 10, wherein the network service attributes include at least one of Fiber-to-the-Premises (FTTP) capability, Optical Network Terminal (ONT) information, wire center and rate center information, or line status information.

12. The computer-readable medium of claim 11, where the ONT information includes at least one of ONT installation information, Session Initiation Protocol (SIP) enablement information, or digital voice capability.

13. The computer-readable medium of claim 11, wherein the wire center and rate center information includes a wire center identifier and a rate center name.

14. A mobile device, comprising:
a communication interface;
a display device;
one or more processing units configured to:
obtain a geographic location of the mobile device,
cause a geographic location associated with the mobile device to be sent to a remote network device via the communication interface,
receive, via the communication interface, addresses, of customers who subscribe to a network service, that are within a distance parameter of the geographic location,
receive, via the communication interface, network service attributes associated with the addresses of the customers, and
cause the display device to display the addresses of the customers on a map and to cause the network service attributes for at least one of the addresses to be displayed in association with the map.

15. The mobile device of claim 14, wherein the mobile device comprises a mobile computational device and wherein the communication interface comprises a wireless communication interface.

16. The mobile device of claim 15, wherein the mobile device comprises a laptop, palmtop or tablet computer, a cellular telephone, or a personal digital assistant (PDA).

17. The mobile device of claim 14, wherein the network service attributes include information associated with one or more network services that are provided to the addresses of the customers.

18. The mobile device of claim 14, wherein the network service attributes include at least one of Fiber-to-the-Premises (FTTP) capability, Optical Network Terminal (ONT) information, wire center and rate center information, or line status information.

19. The mobile device of claim 18, where the ONT information includes at least one of ONT installation information, Session Initiation Protocol (SIP) enablement information, or digital voice capability.

20. The mobile device of claim 18, wherein the wire center and rate center information includes a wire center identifier and a rate center name.

21. A network device, comprising:
a communication interface configured to receive a geographic location of a mobile device;
a processing unit configured to:
access a database to identify addresses within a distance parameter of the received geographic location,
retrieve attributes associated with the identified addresses from the database,
wherein the attributes comprise attributes associated with one or more network services provided to customers from a network service provider, and
cause the identified customer addresses and the retrieved network service attributes to be sent to the mobile device via the communication interface.

22. The network device of claim 21, wherein the processing unit is further configured to:
generate marketing offers associated with one or more network services for one or more of the identified addresses, and
cause the generated marketing offers to be sent to the mobile device via the communication interface.

23. The network device of claim 22, wherein the marketing offers include discounts for upgrading existing network services or for adding to existing network services.

24. The network device of claim 21, wherein the attributes include at least one of Fiber-to- the-Premises (FTTP) capability, Optical Network Terminal (ONT) information, wire center and rate center information, or line status information.

25. The network device of claim 24, where the ONT information includes at least one of ONT installation information, Session Initiation Protocol (SIP) enablement information, or digital voice capability.
